(19) United States
(12) Patent Application Publication
(10) Pub. No.: US 2008/0142119 A1
(43) Pub. Date: Jun. 19, 2008

(54) Router guide for different width doors

(76) Inventor: Felix C. Ponce, Reseda, CA (US)

Correspondence Address: BUHLER ASSOCIATES;BUHLER, KIRK A., 1101 CALIFORNIA AVE., SUITE 208, CORONA, CA, 92881, US

(21) Appl. No.: 11/640,756

(22) Filed: Dec. 19, 2006

(51) Int. Cl. B27C 5/00

(52) U.S. Cl. 144/144.51

(57) ABSTRACT

Improvements in an adaptable router template guide are disclosed. The router guide is adjustable for door or door jam widths of 1⅜, 1¾ and 2¼ with simple spring loaded stops and detents. Interchangeable routing templates are also provided to accommodate different size and shapes of striker plates, hinge plates and door jambs. The router template further includes debris ports for removal of sawdust. In operation the router guide is set for the width of the door and secured to the door or door frame. The correct plate is installed on into the guide and the pocket is routed. The combinations of door width and template plates allows the guide to be used with numerous styles of door hardware that are both currently manufactured and may be available in the future.

### FIELD OF THE INVENTION

The present invention relates to a universal router guide for use with doors and door jams of different widths. In particular the router guide is adjustable for doors of 1⅜, 1¾ and 2¼ inch widths and includes a number of changeable router guide plates to match the dimensions of the plate to be recessed. The router template further includes debris ports for removal of sawdust.

### BACKGROUND OF THE INVENTION

When doors are installed into door frames the hardware such as hinges, striker plates and lock set typically have a plate that is reset into the door or door frame. The shape of the pockets is often variable based upon the manufacturer and the type of lock or hinge. Various types of fixtures and jigs have been designed for use with a router to cut these pockets or recesses. Some of these various fixtures have included clamping devices for holding pieces of wood. Several of the fixtures have included some form of a template for a router to follow in order to provide a surface design or to form certain cuts for an appropriate joint.

U.S. Pat. No. 3,841,368, issued on Oct. 15, 1974 to Nicholas H. Ritter discloses a routing device which has parallel guides on a guide base to position a work piece. A tool platform to position and support the tool, a tool support plate and a frame to provide angular movement of the tool, and selective indexing mechanisms which are disposed between the parallel guides and the frame, the frame and the blade, and the tool platform and the tool support plate. While this device discloses a router template the template does not allow for attachment to door or door frames of different thicknesses, or does it disclose a changeable router template or ports for debris discharge.

U.S. Pat. No. 4,356,849, issued Nov. 2, 1982 to Donald L. Fredrickson discloses a Molding Curvature Template Fixture, which holds a strip of molding and provides a template for a portable router to follow the shape of the molding to make molding with a similar cross-sectional shape of the shaped side of the molding. The fixture includes a box-section frame which has a series of lateral slots and a clamping mechanism. An insert may be attached to the box section frame to provide a guiding surface for cutting molding which has a non-standard shape. While this device discloses a router template the template does not allow for attachment to door or door frames of different thicknesses, or does it disclose a changeable router template or ports for debris discharge.

U.S. Pat. No. 4,323,100 issued Apr. 6, 1982 to Howard Silken discloses a Router Guide that includes an attachment to the base of a router with a central opening for passing the router bit. On the bottom, the guide plate has a series of openings spaced apart along a spiral of progressively increasing radius which has the central opening as its center. A pivot pin is selectively insertable into any one of these openings. The pivot pin has a pointed end for insertion in a work piece at the center of a circular groove which is to be cut in the work piece by the router bit as the guide plate is rotated about the pivot pin. While this device discloses a router template the template does not allow for attachment to door or door frames of different thicknesses, or does it disclose a changeable router template or ports for debris discharge.

U.S. Pat. No. 4,319,615, issued Mar. 16, 1982 to Henry A. Ditmanson discloses a Router Attachment for Ornamenting a Work piece that includes a set of adjustable rails on a track which can be oriented in any given direction by placing the track on a turntable. A wheeled carriage rides to or fro on the track and carries a router. The router bit rises and falls in response to the particular profile of the rails and cuts recesses in an underlying work piece which has shapes dependent on rail contour, bit size and shape and extent of carriage travel. While this device discloses a router template the template does not allow for attachment to door or door frames of different thicknesses, or does it disclose a changeable router template or ports for debris discharge.

U.S. Pat. No. 4,299,263, issued Nov. 10, 1981 to Charles D. Skinner discloses a Mechanical Router Guide. The router guide allows the router to move above the surface of a stationary piece, whereby the router is subject to a composite, and three directional movement as it is moved above the work piece. The indexing table carries a template holding frame which can be slanted at an adjustable angle in relation to the work piece in order to create designs of varying depth and width into the work piece. While this device discloses a router template the template does not allow for attachment to door or door frames of different thicknesses, or does it disclose a changeable router template or ports in the template for debris discharge.

### BRIEF SUMMARY OF THE INVENTION

It is an object of the universal router guide to provide a woodworking fixture which holds a portion of a door and provides a template for use with a portable router for cutting an opening for a latch face on the door or door frame. The router guide is essentially a rectangular configuration with a flat top and bottom. The guide is secured to a door or door frame with kept nails what are driven into the door or door frame to maintain the position of the guide. The elongated sides of the guide are configured to mate with the door or door frame to a fit that minimizes the movement of the guide on the frame of door.

It is another object of the universal router guide to provide a door width adjustment mechanism that adapts the router guide to three different width doors. The adjustment is accomplished using solid stops consisting of a slot with screws and spring loaded pin(s) that prevent travel beyond the screws or pins. The pins are depressed to allow the stop plate to move beyond the spring loaded pin(s). Identification is placed on the guide to indicate the width of the door that is being routed. Stops are provided on both ends of the universal router guide to maintain a parallel relationship of the guide to the door or door frame.

It is another object of the universal router guide to provide a guide with changeable routing templates. The templates are secured into the guide and match the area that needs to be routed from the door or door frame. The universal nature of the guide allows a nearly endless variety of different plates to be attached for currently available shapes as well as shapes that will be available in the future. The plates are typically secured within the guide using threaded hardware that provides a flush top surface that does not interfere with the base of a portable router.

It is still another object of the universal router guide is to provide a router guide with side ports that allow removed material to be discharged out the side of the guide. In many installations the debris remains inside the guide until the routing operation is complete. The debris discharge holes keep the area within the guide clear allowing better visibility of the area being routed.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 shows a top isometric view of a universal latch template.

FIG. 2 shows a top isometric view of a universal strike template with a number of different routing templates.

FIG. 3 shows a detailed top isometric view of the three position door thickness stop gauge.

FIG. 4 is a bottom isometric view of the template showing the debris vents.

### DETAILED DESCRIPTION

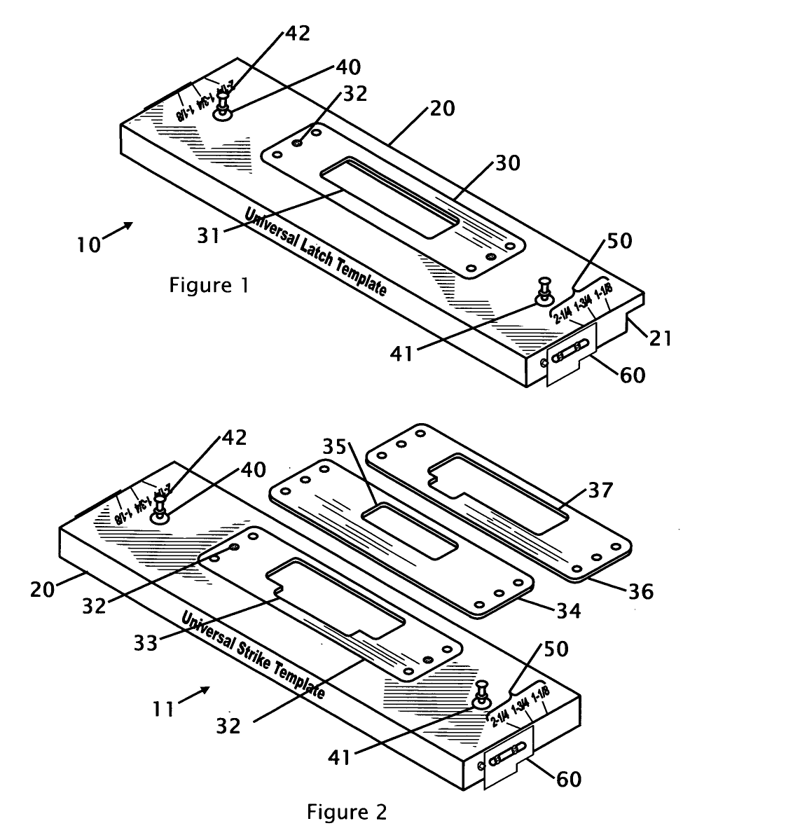

Referring first to FIG. 1 that shows a top isometric view of a universal latch template 10. The template is essentially a flat rectangular shape 20. In the preferred embodiment the template is fabricated from wood, but it is also contemplated that the template can be made from metal, plastic or other similar material that has sufficient structural rigidity to provide the functions herein disclosed. The template has two elongated sides with a central cut-out area with a depression where a router guide 30 in installed. When the template is configured as a latch template, an elongated recess 21 exists on one side of the template to locate the template in a doorway door jamb.

The router guide 30 is removable from the template and can be changed to accommodate different size and shaped pockets that need to be routed. In this figure the router guide 30 is shaped for a rectangular opening 31. Other router guides are shown and described in more detain with FIG. 2 herein. The router guide is secured to the template with threaded fasteners 32 such as screws, but other types of securing methods are contemplated. Screws are preferred because they allow the fasteners to sit flush below the top surface of the router guide 30. The template is temporally retained on the door or door frame with a removable nail 42. These removable nails are retained in a base 40 and 41 that both guide the nail and allow the nail(s) to be easily removed after the routing operation is complete.

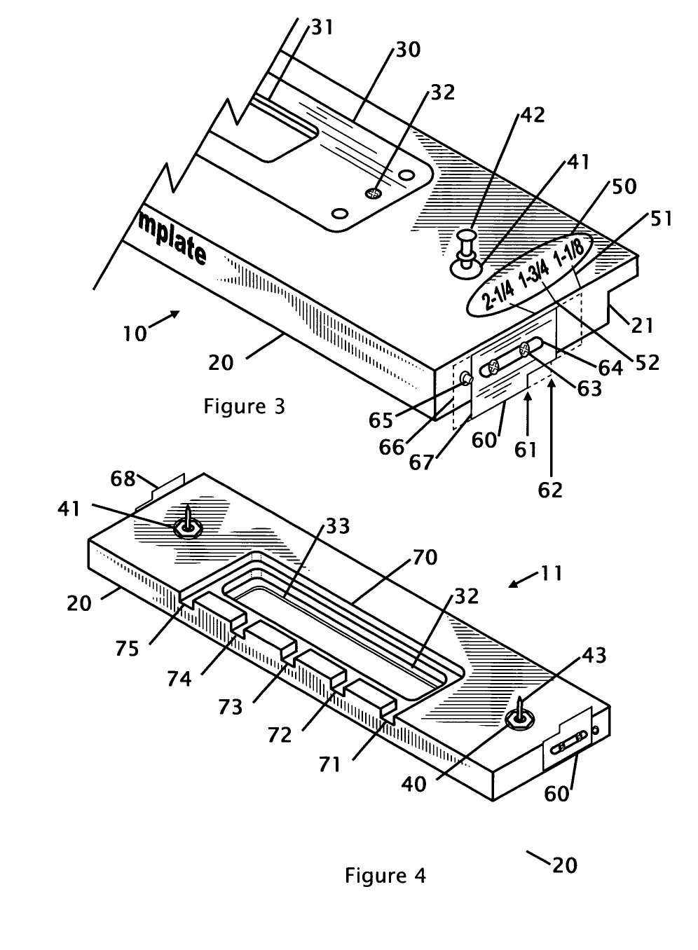

In operation the template is brought into position on the door or door frame and the removable nails are driven into the door or door frame. The recessed pocked in the door or door frame is routed and the template is removed. Both sides of the template have indicator plates 60 to adjust the template for the width of the door or doorjamb width. In the preferred embodiment the adjustment 60 is for three widths of 1⅜, 1¾ and 2¼ inch as identified with item 50. The features of the indicator plate is shown and described in more detail in FIG. 3. In a brief description of this feature it utilizes a slot with travel stops and a spring loaded pin to positively indicate the location where the stop indicator plate 60 should be placed.

FIG. 2 shows a top isometric view of a universal strike template 11 with a number of different routing templates. This template is for routing the striker plate as opposed to the latch plate as shown and described in FIG. 1. The major difference between these two templates is the notch 20 that is present in the template shown in FIG. 1 but is not present in the template shown in FIG. 2. A third template for hinges is not shown, but the construction and the features are similar to the templates shown and described herein.

The template shown in FIG. 2 is essentially a flat rectangular shape 20. The template has two elongated sides with a central cut-out area with a depression where a router guide 32 in installed. The router guide is retained in the template with screws or similar hardware that allows the router guides to be removed or removable. In this figure one router guide 32 is installed in the template with an opening in the guide 33 that corresponds to the area that will be routed from a door. A second router guide 34 is shown with its corresponding area 35 that will be routed and a third router guide 36 is shown with its corresponding area 37 that is routed. While only three router guides are shown many different router guides are contemplated that correspond to the striker plates that are available from lock, hinge or similar hardware manufacturers. Because the template can universally accept different router guides the template is usable with lock set that have not yet been design, or used in construction. The template is temporally retained on the door with a removable nail 42. These removable nails are retained in a base 40 and 41 that both guide the nail and allow the nail(s) to be easily removed after the routing operation is complete.

Both sides of the template have indicator plates 60 to adjust the template for the width of the door. In the preferred embodiment the adjustment 60 is for three widths of 1⅜, 1¾ and 2¼ inch as identified with item 50. The features of the indicator plate is shown and described in more detail in FIG. 3.

FIG. 3 shows a detailed top isometric view of the three position door thickness stop gauge. The template shown in this figure is for the universal latch template 10. Only one end of the elongated template 20 is shown to provide detail on the indicator plate 60 and its function. The template 20 is shown with the elongated recess 21, a router guide 30 secured in the template with recessed screw 32, and the opening for the router guide 31. The template is temporally retained on the door frame with the removable nail 42 in the base 41 to allow the nail(s) to be easily removed after the routing operation is complete. Marking locations 50 identify where the indicator plate is to be positioned for door frames or doors of various widths. The numerical values corresponding to the door widths and a leader line 51 shows the preferred position for the indicator plate. The plate 60 is shown in a position indicating 1¾ inch thick door shown with mark 52. The position of the plate is positively identified when the edge 67 of the plate is against the stop 65. It should be noted that the plate 60 is shown located such that the screws 63 in the slot 64 exist in the middle travel position.

To obtain the 1⅛ inch thick door position the screws 63 are loosened and the plate 60 is slid all the way to the right so the body of the screw prevents further travel of the plate. This places the template in a position shown with dashed line 62. To obtain the position 51 of the plate for the 1¾ inch thick door the screws 63 are loosened and the plate is slid to the left until it contacts pin 65. To obtain the 2¼ inch thick door position the pin 65 is depressed and the plate 60 is slid over the top of the depressed pin until the edge of the plate 60 stops against the right screw 63. This places the template in a position shown with dashed line 66. In operation the edge 61 is used to position the template on the side of the door frame. While the spring loaded pin allows for three different positive stop positions it is contemplated that more than one spring loaded pin can be used to provide more than three discrete stop positions.

FIG. 4 is a bottom isometric view of the template 11 showing the debris vents. This underside view shows the bottom edges of the indicator plates 60 and 68 located on the ends of the elongated template 20. The ends of the plates are shown rising above the surface of the template. The removable nails 40 and 41 are shown with the nail 43 sticking out beyond the end of the removable nail holders 40 and 41. A portion of the bottom of the router guide 32 is seen with the opening 33 in the router guide. There is a recess 70 in the bottom of the template that provides clearance for the debris that is routed away. Vents 71-75 extend to the sides of the template to allow debris to be expelled out the sides of the template. In the figure shown five vents are shown, but as few as one or more than five vents can be used. The use of multiple vents allows for the area between the vents to sit solidly against the door or door frame that makes the template more stable when routing a pocket.

Thus, specific embodiments of universal router template have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. An adaptable router template guide comprising:
a rectangular router base adapted for securing the router base onto a door or door frame wherein the router base has physical stops to allow the router base to locate on at least three different width doors or door frames to ensure routing a pocket in the desired location.

2. The adaptable router template guide from claim 1 wherein at least one of the physical stops includes a spring loaded pin that is temporally depressed to bypass the spring loaded physical stop to allow the guide to utilize another physical stop that exists on the other side of the spring loaded pin.

3. The adaptable router template guide from claim 1 that further includes locating plates located on narrow ends of the base that are positionable on the physical stops to set the width of the door or door frame.

4. The adaptable router template guide from claim 1 wherein they physical stops are not adjustable.

5. The adaptable router template guide from claim 1 that further includes markings to correlate the physical stops with the door or door jam width.

6. The adaptable router template guide from claim 1 that further includes at least one vent located on the bottom of the guide to allow for removed debris to be expelled from within the guide.

7. The adaptable router template guide from claim 1 that further includes changeable router templates that can be removed and replaced for routing different size and shape recesses.

8. An adaptable router template guide comprising:
a rectangular router base adapted for securing the router base onto a door or door frame wherein the router base includes changeable router templates that can be removed and replaced for routing different size and shape recesses that relate to different hinges, striker plates or lock sets.

9. The adaptable router template guide from claim 8 wherein the templates are removably secured to the rectangular router base.

10. The adaptable router template guide from claim 8 wherein the templates are constructed to correspond to existing hinge patters, striker plate patters, or lock set patterns.

11. The adaptable router template guide from claim 8 wherein templates are not adjustable.

12. The adaptable router template guide from claim 8 further includes adjustable stops to size the guide to the width of the door or door frame.

13. The adaptable router template guide from claim 8 that further includes physical stops to allow the router base to locate on at least three different width doors or door frames to ensure routing a pocket in the desired position.

14. The adaptable router template guide from claim 8 that further includes at least one vent located on the bottom of the guide to allow for removed debris to be expelled from within the guide.

15. An adaptable router template guide comprising:
a rectangular router base adapted for securing the router base onto a door or door frame wherein the router base includes at least one vent located in the side of the base to allow for removed debris to be expelled from within the guide.

16. The adaptable router template guide from claim 15 wherein the bottom of the base has an island portion to provide structural support under the router base with a plurality of vents to maximize debris expelling.

17. The adaptable router template guide from claim 15 wherein the vents exist on both sides of the template.

18. The adaptable router template guide from claim 15 wherein a plurality of vents exist.

19. The adaptable router template guide from claim 15 that further includes changeable router templates that can be removed and replaced for routing different size and shape recesses.

20. The adaptable router template guide from claim 15 that further includes physical stops to allow the router base to locate on at least three different width doors or door frames to ensure routing a pocket in the desired position.
